(19) United States
(12) Patent Application Publication
(10) Pub. No.: US 2026/0030636 A1
(43) Pub. Date: Jan. 29, 2026

(54) RENEWABLE-AWARE PRELIMINARY DATA CENTR COMBINATION SELECTION AND APPLICATION RELOCATION METHOD

(71) Applicant: Hitachi Vantara, Ltd., Yokohama-shi (JP)

(72) Inventors: Taku OKAMURA, Sunnyvale, CA (US); Hiroyuki Osaki, Los Gatos, CA (US); Takanobu Suzuki, San Jose, CA (US); Kazuei Hironaka, Campbell, CA (US)

(21) Appl. No.: 18/787,033

(22) Filed: Jul. 29, 2024

(51) Int. Cl. G06Q 30/018; G06F 9/50

(52) U.S. Cl. CPC G06Q 30/018; G06F 9/5088

(57) ABSTRACT

Systems and methods described herein are directed to reduction of carbon emissions through data center workload control for controlling the migration of workloads between a first data center and one or more second data centers from a plurality of data centers based on renewable energy supply, including calculating a complementary score of each of the plurality of data centers based on information of time-series data of past renewable energy supply at the each of the plurality of data centers, determining the one or more second data centers as destination data centers for creation of remote copies to one or more volumes based on the complementary score; and executing creation of the remote copies to the one or more second data centers.

### BACKGROUND

### Field

The present disclosure is generally directed to data centers (DCs), and more specifically, to carbon emission reduction for data centers through renewable aware management systems for data centers.

### Related Art

Data centers serve as the backbone for today's technology-dependent society. They handle large number of workloads to execute multiple applications. Because the number of applications executed has been increasing, the growing power consumption of data centers has become a major concern. In order to reduce carbon emissions associated with electricity generation, the decarbonization of data centers has been advanced by utilizing power from renewable sources.

One promising approach to decarbonize data centers is to control electricity demand of data centers to match renewable energy supply. Recently, there are attempts to control the power consumed by data centers by controlling processing workloads executed by a data center over spatially among multiple data centers, thereby improving the energy efficiency of the data center.

One big challenge to utilize renewable energies is that they have an intermittent nature, therefore the amount of produced power varies over time. To improve the renewable energy usage through the spatial control of workloads, it is necessary to control workloads at time intervals of a few minutes to a few hours.

In the present disclosure, the term ‘RE ratio’ is used for as an indicator of the degree of renewable energy usage in data centers, which measures the amount of renewable energy supplied per hour relative to the data center's power consumption.

In the related art, there are methods for relocating workloads across data centers, and workloads to be relocated are identified based on recent power source information.

### SUMMARY

Related art implementations do not have any method for identifying workloads to be relocated in advance because it determines the data center based on recent power source information. This causes a problem when users need to relocate a stateful workload, which records previous transactions and enables users to resume previous operations such as database applications. Since it takes a long time to copy data to another data center, the migration of a stateful workload cannot follow the changes in renewable energies. Accordingly, the RE ratio cannot be improved through the related art implementations.

Aspects of the present disclosure involve a method for determining a data center to make a copy from among several data centers by calculating the degree of renewable energy supplementation based on the historical data of renewable energy supply at data centers; and a method for improving the RE ratio by swapping volume attributes and relocating associated applications between one data center and the data center determined above in response to fluctuations in renewable energy.

Aspects of the present disclosure can involve a workload control system that controls the migration of workloads between a first data center and one or more second data centers from a plurality of data centers based on renewable energy supply, involving, a processor, configured to, calculate a complementary score of each of the plurality of data centers based on information of time-series data of past renewable energy supply at the each of the plurality of data centers, determine the one or more second data centers as destination data centers for creation of remote copies to one or more volumes based on the complementary score; and execute the creation of the remote copies to the one or more second data centers.

Aspects of the present disclosure can involve a workload control method for controlling the migration of workloads between a first data center and one or more second data centers from a plurality of data centers based on renewable energy supply, involving, calculating a complementary score of each of the plurality of data centers based on information of time-series data of past renewable energy supply at the each of the plurality of data centers, determining the one or more second data centers as destination data centers for creation of remote copies to one or more volumes based on the complementary score; and executing the creation of the remote copies to the one or more second data centers.

Aspects of the present disclosure can involve a workload control system for controlling the migration of workloads between a first data center and one or more second data centers from a plurality of data centers based on renewable energy supply, involving, means for calculating a complementary score of each of the plurality of data centers based on information of time-series data of past renewable energy supply at the each of the plurality of data centers, means for determining the one or more second data centers as destination data centers for creation of remote copies to one or more volumes based on the complementary score; and means for executing the creation of the remote copies to the one or more second data centers.

Aspects of the present disclosure can involve a computer program, storing instructions for executing a workload control process for controlling the migration of workloads between a first data center and one or more second data centers from a plurality of data centers based on renewable energy supply, involving, calculating a complementary score of each of the plurality of data centers based on information of time-series data of past renewable energy supply at the each of the plurality of data centers, determining the one or more second data centers as destination data centers for creation of remote copies to one or more volumes based on the complementary score; and executing the creation of the remote copies to the one or more second data centers. The computer program and instructions can be stored on a non-transitory computer readable medium and executed by one or more processors.

### BRIEF DESCRIPTION OF DRAWINGS

FIG. 1 illustrates a system overview in accordance with a first example implementation.

FIG. 2 shows an example of DC Power Management table 130, in accordance with an example implementation.

FIG. 3 shows an example of Volume/Pair Management Table 140, in accordance with an example implementation.

FIG. 4 illustrates an example of Application Management Table 150, in accordance with an example implementation.

FIG. 5 illustrates an example of Threshold Table 330 managed by DC Management Server 300, in accordance with an example implementation.

FIG. 6 illustrates an example flow for creating a remote copy in Copy Creation Program 310, in accordance with an example implementation.

FIG. 7 illustrates an example flow in Copy Creation Program 310, in accordance with an example implementation. This is a detailed flow of Step S110.

FIG. 8 illustrates an example flow in Workload Migration Program 320, in accordance with an example implementation.

FIG. 9 illustrates an example screen image displayed by the DC Management Server 300 to the User 230 to ask them to enter information to identify an application, in accordance with an example implementation.

FIG. 10 illustrates an example flow for configuring and constructing the remote copy, swapping primary and secondary volumes, and moving the application according to renewable energy fluctuations, in accordance with an example implementation.

FIG. 11 illustrates an example computing environment with an example computer device suitable for use in some example implementations.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

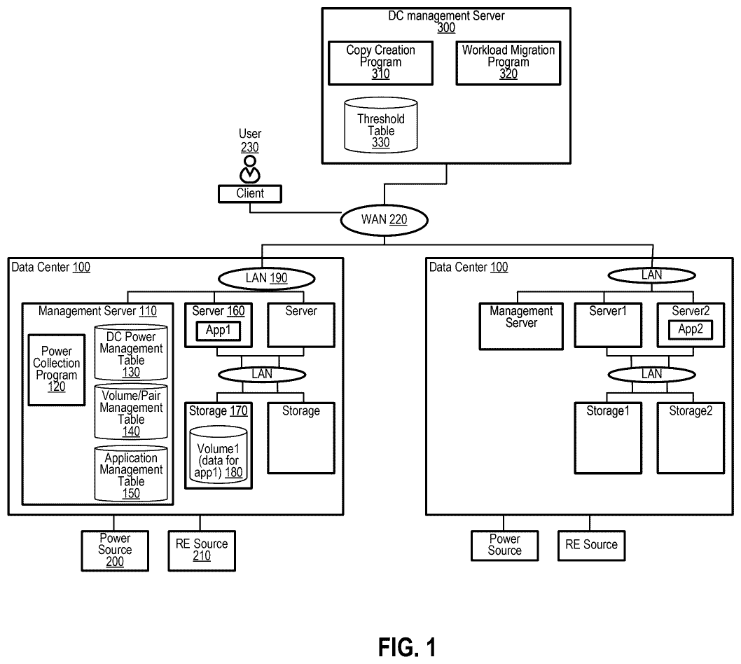

FIG. 1 illustrates a system overview in accordance with a first example implementation. The system includes multiple data centers 100 and DC Management Server 300, which are connected to each other via a network such as Wide Area Network (WAN) 220.

Each data center has a management server 110, one or more servers 160 used by users 230, and one or more storage devices 170 used by users 230. Servers 160, storage devices 170, and the management server 110 are connected to each other by a network such as Local Area Network (LAN) 190.

Devices in a data center 100, such as the management server 110, are driven by electric power supplied by power source 200 and Renewable Energy (RE) source 210. RE sources 210 are solar, wind, and other renewable energy generation facilities located inside or outside the data center 100, and the power generated there can be used within that data center 100. Power source 200 is a source of power other than renewable energy (e.g., a grid power source).

Servers 160 execute various applications by users, and storage devices 170 store volumes 180 for storing data to be utilized by applications.

The management server 110 stores Power Collection Program 120 and the following tables: DC Power Management Table 130, Volume/Pair Management Table 140, and Application Management Table 150.

DC Power Management Table 130 stores information on the power consumed by the data center and the power supplied to the data center. Volume/Pair Management Table 140 maintains information on a list of volumes stored on storage devices 170. Application Management Table 150 stores information on a list of running and executed applications on servers 160.

Power Collection Program 120 monitors the power consumed in the data center 100, which is the sum of power consumed by servers, storage devices, etc., and stores the records to DC Power Management Table 130. It also monitors the power supplied by RE source 210 and records it in DC Power Management Table 130.

DC Management Server 300 stores Copy Creation Program 310, Workload Migration Program 320, and Threshold Table 330, which are necessary for the creation of copy pairs and the migration of apps between data centers. Threshold Table 330 stores information on thresholds for renewable energy ratio and the number of pairs.

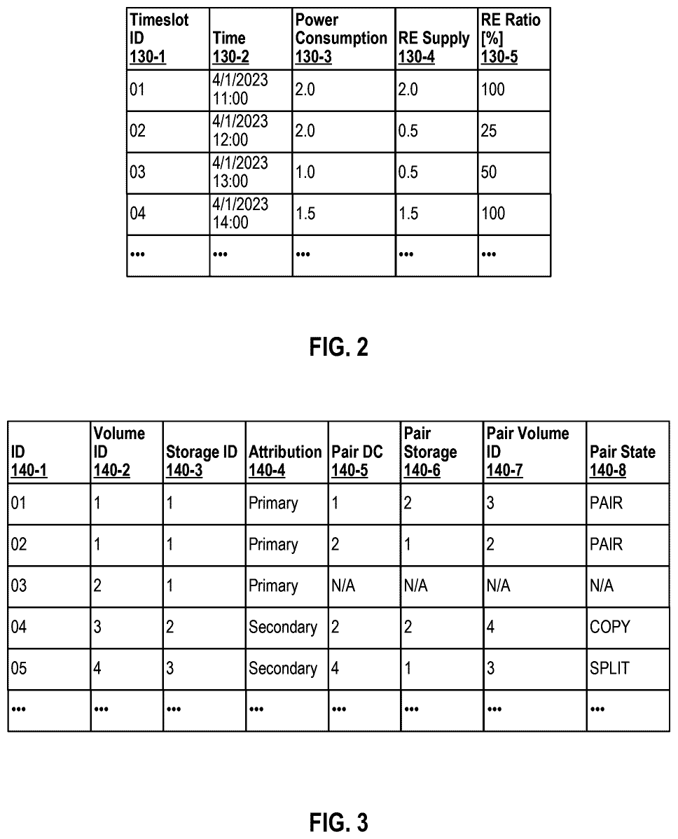

FIG. 2 shows an example of DC Power Management table 130, in accordance with an example implementation. This table is managed by Management Server 110. This table has information about power that each data center consumes at each timeslot. Each data center has one DC Power Management table 130 to record its own power consumption. Each entry of this table has Timeslot identifier (ID) 130-1, Time 130-2, Power Consumption 130-3, RE Supply 130-4, and RE Ratio 130-5.

Timeslot ID 130-1 is an identifier of a time slot. Time 130-2 indicates the specific time referenced by the Timeslot ID 130-1. Power Consumption 130-3 is information regarding how much power the data center consumed at the time slot. RE Supply 130-4 is information that indicates how much renewable energy power is supplied to the data center from RE Source 210 at the time slot. RE Ratio 130-5 is information that indicates the ratio of power consumption that is covered by renewable energy to that is consumed in the time slot.

FIG. 3 shows an example of Volume/Pair Management Table 140, in accordance with an example implementation. This table is managed by Management Server 110. This table has information about volumes which are stored at storage devices 170 and pairs that are created to the volumes. Each entry of this table has ID 140-1, Volume ID 140-2, Storage ID 140-3, Attribution 140-4, Pair DC 140-5, Pair Storage 140-6, Pair Volume ID 140-7, and Pair State 140-8.

ID 140-1 is an identifier. Volume ID 140-2 is an identifier of a volume that is stored in a data center. Storage ID 140-3 is information regarding the storage that owns the volume. Attribution 140-4 is information regarding an attribute of the volume. Examples of attributes can include Primary and Secondary. Primary indicates a volume associated with an application, to which data is written directly from the application. Secondary indicates a volume that is paired with a Primary volume, and data is copied from a Primary volume to the volume. Other statuses may be taken in accordance with the desired implementation, and the present disclosure is not limited thereto.

Pair DC 140-5 is information regarding a data center where a pair volume has been created. A volume can have copy pairs in multiple data centers. If a pair is not created, N/A is listed. Pair Storage 140-6 is information regarding storage where a pair volume has been created. If a pair is not created, N/A is listed.

Pair Volume ID 140-7 is information regarding a pair volume. If no pair is created, N/A is listed. Pair State 140-8 represents the status of a pair. Examples of statuses are COPY, PAIR, and SPLIT. COPY means that a copy relationship has been established and initial copy is being executed. PAIR means that the initial copy has completed and updated differences are continuously synchronized. SPLIT means that copying is stopped. If a pair is not created, N/A is listed. Other statuses may be taken in accordance with the desired implementation, and the present disclosure is not limited thereto.

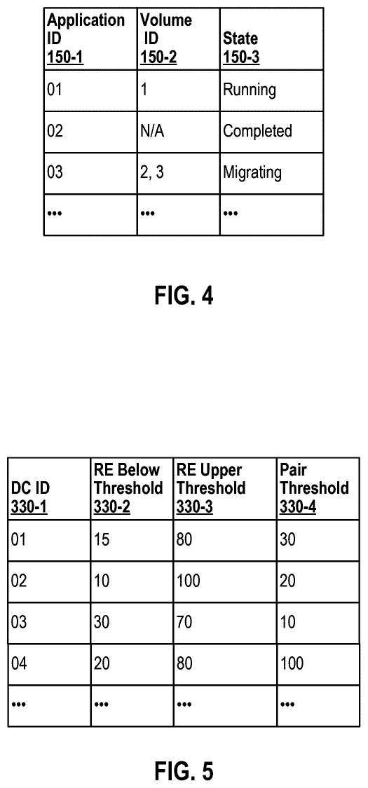

FIG. 4 illustrates an example of Application Management Table 150, in accordance with an example implementation. This table is managed by Management Server 110. This table has information regarding applications that are being executed and were executed in a data center. Each entry has Application ID 150-1, Volume ID 150-2, and State 150-3. Application ID 150-1 is an identifier of the application. Volume ID 150-2 is information regarding volumes that associated with the application. If an application does not have a volume, N/A is listed. An application can has several volumes. In that case, multiple volume IDs are stored for one application ID.

State 150-3 represents the status of the application. Examples of statuses are Running, Completed, and Migrating. Running means that the application is running. Completed means that the application has completed and is not currently running. Migrating means that the application is being migrated to another data center.

FIG. 5 illustrates an example of Threshold Table 330 managed by DC Management Server 300, in accordance with an example implementation. This table has information regarding thresholds for renewable energy ratio and the number of pairs. Each entry has DC ID 330-1, RE Below Threshold 330-2, RE Upper Threshold 330-3, and Pair Threshold 330-4.

DC ID 330-1 is an identifier of the data center. RE Below Threshold 330-2 is a threshold for RE ratio; that is, when the RE ratio falls below the value, then application migration will be performed. RE upper threshold 330-3 is a threshold for RE ratio; that is, when the RE ratio recovers to this threshold, the application migration will be stopped. Pair threshold 330-4 is a threshold for the number of pairs that can be created in the data center.

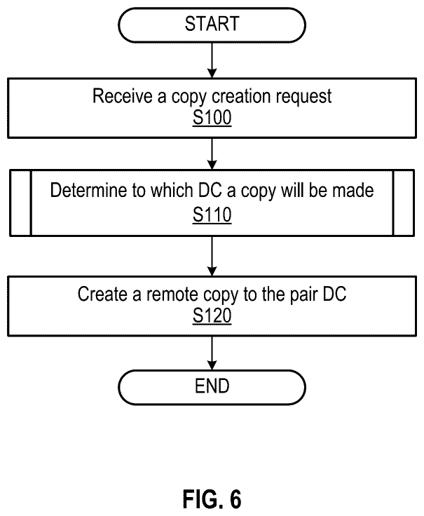

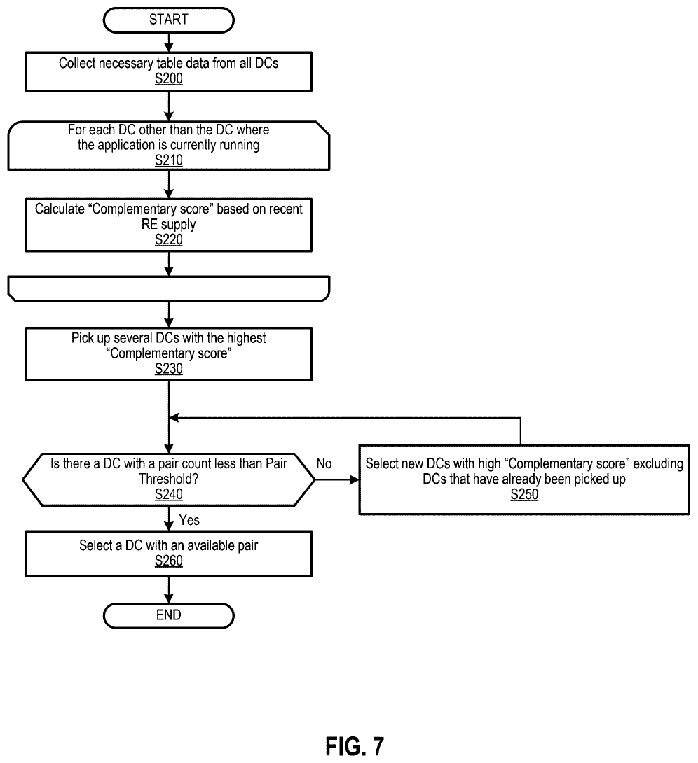

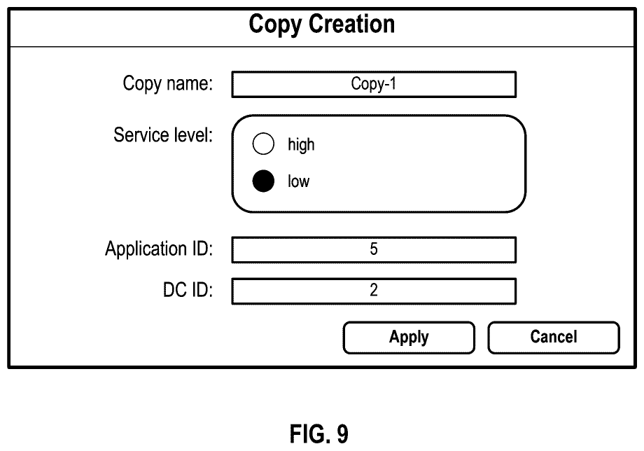

FIG. 6 illustrates an example flow for creating a remote copy in Copy Creation Program 310, in accordance with an example implementation. Step S100 starts when the Copy Creation Program 310 receives a copy creation request for an application. This request is submitted by a user through the user interface described later in FIG. 9. At Step S110, the process determines in which data center to create a remote copy. The detail of this step is described in the flow in FIG. 7. At Step S120, the process creates a remote copy for every volume associated with the application to the data center determined in Step S110. Secondary volumes are created in the data center, and the initial copy is initiated.

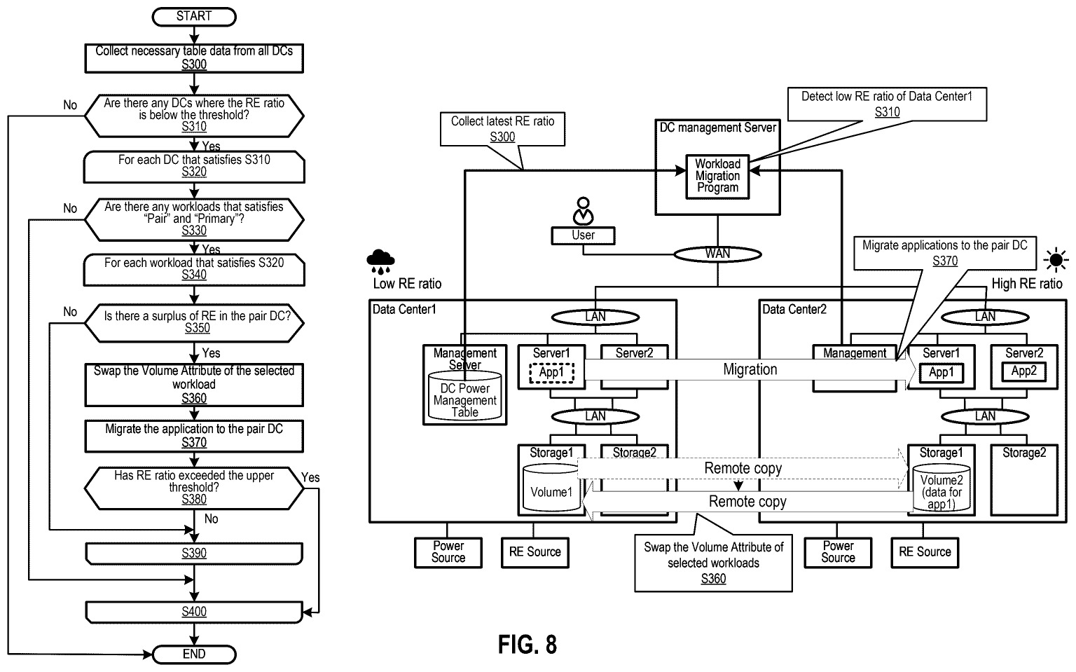

FIG. 7 and FIG. 8 illustrate the series of flows where the Copy Creation Program 310 determines the destination data center for copying and migrates the workload. First, the flow shown in FIG. 7 involves determining a data center to make a copy from among several data centers by calculating the degree of renewable energy supplementation based on the historical data of renewable energy supply at data centers. Then, the flow shown in FIG.8 involves swapping volume attributes and relocating associated applications between one data center and the data center determined above, in response to fluctuations in renewable energy.

FIG. 7 illustrates an example flow in Copy Creation Program 310, in accordance with an example implementation. This is a detailed flow of Step S110. Step S200 starts at Step S110. At step S200, the data necessary to calculate the “Complementary Score” in step S220 and to select a data center in steps S230-S260 are collected from all data centers. In detail, the process collects data from DC Power Management Table 130 and Volume/Pair Management Table 140 stored at Management Server 110. If there are multiple data centers other than the data center where the application which is selected at step S100 is running, steps S220 is processed for each data center other than the data center.

At Step S220, the process calculates the complementary score based on recent RE supply 130-4 for the currently targeted data center. Here, the complementary score is an indicator of how much the renewable energy supply are complementary between the data center and another data center currently selected at step S210. A high complementary score means that when the supply of renewable energy at one data center is low, the supply of renewable energy at the other data center is high, and vice versa. For example, this score can be calculated by summing the historical data on renewable energy supply of the two data centers for the same time slot over the last month and calculating the standard deviation over the time series. Other methods may be taken in accordance with the desired implementation, and the present disclosure is not limited thereto. By using a DC with a high degree of the complementarity score as a candidate for the placement of the secondary volume (e.g., having differing periods of renewable energy use), even if one DC lacks renewable energy, the other DC is more likely to be able to utilize renewable energy, which can thereby reduce carbon emissions across the pair of data centers. This step is repeated for each data center, except for the currently targeted data center, until the complementary score is computed for all data centers.

At Step S230, the process selects several data centers in order of the complementary score. For example, two data centers are selected, though other numbers of data centers can be selected in accordance with the desired implementation.

At Step S240, the process determines whether any of the data centers selected in step S230 or S250 have fewer pairs than Pair Threshold 330-4. For each data center which is selected in step S230 or S250, the process counts the existing number of pairs based on Volume/Pair Management Table 140 and compares the number with Pair Threshold 330-4 on Threshold Table 330. If there is a data center whose pair count has not reached the threshold, which means that the process can create a new pair in the data center, it proceeds to step S260, else, which means that the process cannot create a new pair in the data center because of a capacity, it proceeds to step S250. In this manner, the created pairs can be distributed across multiple candidate data centers in a manner to meet data center capacity as well as service level agreements by checking which data center copies have been made in the past and avoiding placing too many copies within the same data center.

At Step S250, the process selects several new data centers with high complementary score excluding data centers that have already selected at step S230 or S250. At Step S260, the process finally selects one or two data centers to make a copy based on the capacity of a pair. If a low service level was selected in the User Interface (UI) in FIG. 9, the process selects one data center. On the other hand, a high service level was selected, the process picks up two data centers.

FIG. 8 illustrates an example flow in Workload Migration Program 320, in accordance with an example implementation. Workload Migration Program 320 starts at step S300 at regular intervals, e.g., every 10 minutes. At step S300, the latest RE ratio is collected from all data centers.

At step S310, Workload Migration Program 320 determines whether there is a data center having a RE ratio that is below the RE Below Threshold 330-2. If there are multiple data centers which satisfies the condition of step S310, then steps S320 to S390 are processed for each data center. At S320, each DC that satisfies S310 are processed through a flow as follows.

At Step S330, the process determines if there are workloads with one or more volumes that satisfy the condition where Attribution 140-4 is “Primary” and Pair State 140-8 is “Pair” in Volume/Pair Management Table 140 at the data center. If there is a workload that meets the condition (Yes), it proceeds to step S340, else (No) it proceeds to step S320.

At S340, if there are multiple workloads which satisfies the condition of step S330, steps S350 to S380 are processed for each workload. At Step S350, the process determines if there is a surplus of renewable energy in a data center where the pair volume of the workload is created. If there is a surplus of renewable energy (Yes), the flow proceeds to step S360, else (No) it proceeds to step S340.

At Step S360, the process swaps the volume attribute of the selected workload. It changes the attribute of the volume in the data center with excess renewable energy to ‘Primary’ and the attribute of the volume in the data center with an insufficient amount of renewable energy to ‘Secondary’. If the volume has two pairs, it changes the attribute of the volume in the data center with the highest excess renewable energy to ‘Primary’ and else to ‘Secondary’.

At Step S370, the process relocates the application associated with the workload to the data center with the ‘Primary’ volume. At Step S380, the process monitors the latest RE ratio and determines if the latest RE ratio has exceeded the RE Upper Threshold 330-3. If the latest RE ratio has exceeded the RE Upper Threshold 330-3 (Yes), the flow proceeds to step S400 to process the next data center that satisfies the condition at step S310, else (No) it proceeds to step S390 to process the next workload that satisfies the condition of step S330.

The ability to switch volume attributes instantly allows the application to move in time for renewable energy fluctuations, thereby allowing for control over the use of renewable energy in executing workloads and reducing the overall carbon emissions from the managed data centers.

FIG. 9 illustrates an example screen image displayed by the DC Management Server 300 to the User 230 to ask them to enter information to identify an application, in accordance with an example implementation. At Step S100 in FIG. 6, the User 230 sends a copy creation request through this screen. User 230 names the copy and selects DC ID and Application ID to specify the application. They also select service level of the copy, which determines how many copies are created. If correctly specified, a copy creation is started for the volumes associated with the specified application.

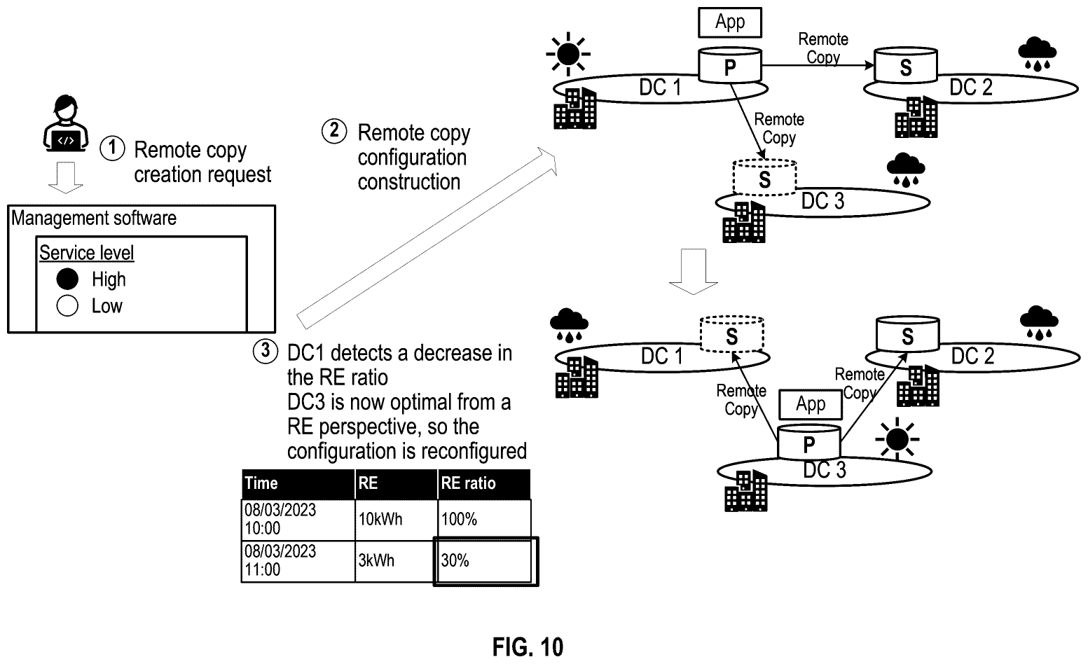

FIG. 10 is a schematic diagram illustrating the application migration flow when the User 230 applies copy creation through the display shown in FIG. 9 and selects the high service level. In this case, copies are configured among three data centers, and the application is migrated between these three DCs. Initially, the application is running in DC1. When the Copy Creation Program 310 receives the instruction for copy creation, it creates copies of the volume (Secondary volumes) in the other two DCs. In this example, Secondary volumes are created in DC2 and DC3. Subsequently, if the RE ratio in DC1 decreases due to adverse weather conditions, the application is migrated to the DC with the most surplus renewable energy between DC2 and DC3. This diagram illustrates an example of migration to DC3. During the application migration, the volume attribute is first changed, and the volume attribute in DC3 is changed to Primary (same as Step S360 in FIG. 8), followed by the migration of the application (same as Step S370 in FIG. 8). As a result, the application runs in DC3, and remote copies are made from DC3 to DC1 and DC2.

Through the example implementations described herein, there can be an improvement of key performance indicators (KPIs) such as renewable energy usage ratio, which thereby leads to a reduction in carbon emissions for managed data centers.

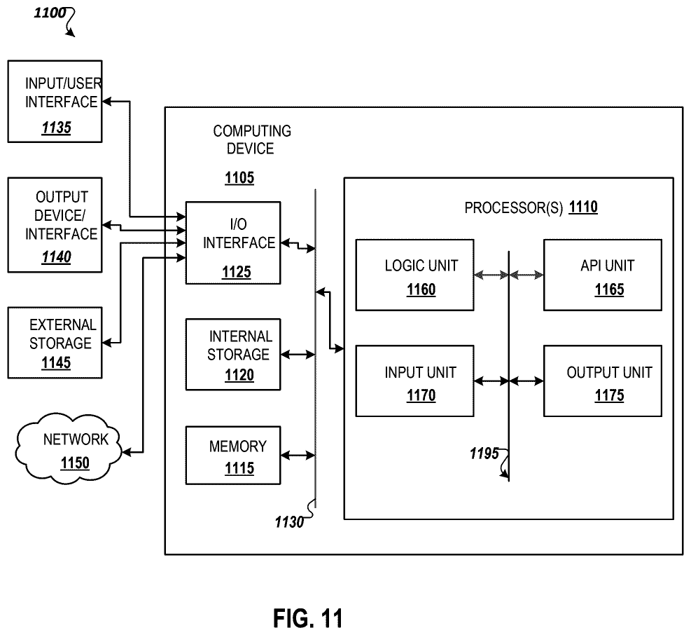

FIG. 11 illustrates an example computing environment with an example computer device suitable for use in some example implementations, such as a workload control system as implemented as a DC Management Server 300 as illustrated in FIG. 1 or by a combination of DC Management Server 300 and one or more of the data centers 100. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or IO interface 1125, any of which can be coupled on a communication mechanism or bus 1130 for communicating information or embedded in the computer device 1105. IO interface 1125 is also configured to receive images from cameras or provide images to projectors or displays, depending on the desired implementation.

Computer device 1105 can be communicatively coupled to input/user interface 1135 and output device/interface 1140. Either one or both of the input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via IO interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

IO interface 1125 can include but is not limited to, wired and/or wireless interfaces using any communication or IO protocols or standards (e.g., Ethernet, 802.11x, Universal System Bus, WiMAX, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, the input unit 1170, the output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide an output based on the calculations described in example implementations.

Processor(s) 1110 can be configured to execute a workload control method or instructions for controlling the migration of workloads between a first data center and one or more second data centers from a plurality of data centers based on renewable energy supply, involving calculating a complementary score of each of the plurality of data centers based on information of time-series data of past renewable energy supply at the each of the plurality of data centers, determining the one or more second data centers as destination data centers for creation of remote copies to one or more volumes based on the complementary score; and executing creation of the remote copies to the one or more second data centers as described with respect to FIGS. 1-7. Through such an example implementation, the reduction of carbon emissions can thereby be achieved through extending utilization of renewable energy sources as described with respect to FIGS. 10A and 10B.

Processor(s) 1110 can be configured to execute the workload control method or instructions as described herein, and further involve, for the renewable energy supply to the first data center falling below a threshold, swapping volume attributes associated with the remote copies to the one or more second data centers, and migrating applications associated with the remote copies from the first data center to the one or more second data centers as described with respect to FIG. 8.

Processor(s) 1110 can be configured to execute the workload control method or instructions as described above, the swapping the volume attributes and migrating the applications involves changing an attribute of a volume in the one or more second data centers having excess renewable energy to a primary volume, and the attribute of the volume in the first data center to secondary volume, wherein the remote copies are to be made from the primary volume; and wherein the remote copies are to be made to the secondary volume as described with respect to FIG. 8.

Processor(s) 1110 can be configured to execute the workload control method or instructions as described above, wherein the determining the one or more second data centers as the destination centers is based on one or more of: a number of remote copies to be created, the capacity of the one or more second data centers, or from selecting from ones of the one or more second data centers having a remote copy pair count that has not reached a threshold as described with respect to FIGS. 1-8.

Processor(s) 1110 can be configured to execute the workload control method or instructions as described above, wherein the calculating the complementary score is based on a standard deviation of a sum of: the time series data of the past renewable energy supply at the each of the plurality of data centers and the time-series data of the past renewable energy supply at the first data center as described with respect to FIGS. 7.

Processor(s) 1110 can be configured to execute the workload control method or instructions, and further involve providing an interface for generating a remote copy creation request, wherein the execution of the creation of the remote copies is conducted to execute the creation of the remote copies to the one or more second data centers in response to the remote copy creation request from the interface; wherein for a renewable energy ratio of the first data center falling below a threshold, swapping the volume attributes and migrating the applications from the first data center to the one or more second data centers as described with respect to FIGS. 7-9.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A workload control system that controls migration of workloads between a first data center and one or more second data centers, wherein the first data center and the one or more second data centers are among a plurality of data centers, and wherein the migration is controlled based on renewable energy supply at the data centers, the system comprising:
a processor, configured to:
calculate a complementary score of each of the plurality of data centers based on information of time-series data of past renewable energy supply at the each of the plurality of data centers,
determine the one or more second data centers as destination data centers for creation of remote copies to one or more volumes based on the complementary score; and
execute creation of the remote copies by creating secondary volumes at the one or more second data centers and initiating copying of data from primary volumes to the secondary volumes to control use of renewable energy in executing workloads and reduce carbon emissions from the plurality of data centers.

2. The system of claim 1, wherein the processor is configured to control the relocation of the applications by changing an attribute of a volume in the one or more second data centers having excess renewable energy to a primary volume, and changing an attribute of a volume in the first data center to a secondary volume, wherein the remote copies are made from the primary volume to the secondary volume.

3. The system of claim 1, wherein the processor is configured to swap the volume attributes by:
determining whether there is excess renewable energy at the one or more second data centers; and
in response to determining there is excess renewable energy, changing an attribute of a volume in the one or more second data centers to a primary volume and changing an attribute of a volume in the first data center to a secondary volume, wherein the remote copies are made from the primary volume to the secondary volume.

4. The system of claim 1, wherein the processor is configured to determine the one or more second data centers as the destination data centers based on one or more of: a number of remote copies to be created, capacity of the one or more second data centers, or from selecting from ones of the one or more second data centers having a remote copy pair count that has not reached a threshold.

5. The system of claim 1, wherein the processor is configured to calculate the complementary score based on a standard deviation of a sum of: time series data of the past renewable energy supply at the each of the plurality of data centers and the time-series data of the past renewable energy supply at the first data center.

6. The system of claim 1, wherein the processor is configured to:
provide an interface for generating a remote copy creation request, wherein the creation of the remote copies is executed by creating secondary volumes at the one or more second data centers and initiating copying of data from primary volumes to the secondary volumes in response to the remote copy creation request from the interface;
wherein for a renewable energy ratio of the first data center falling below a threshold, relocating execution of the applications from servers at the first data center to servers at the one or more second data centers.

7. A workload control method for controlling migration of workloads between a first data center and one or more second data centers, wherein the first data center and the one or more second data centers are among a plurality of data centers, and wherein the migration is controlled based on renewable energy supply at the data centers, comprising:
calculating, by a data center management server a complementary score of each of the plurality of data centers based on information of time-series data of past renewable energy supply at the each of the plurality of data centers,
determining, by the data center management server, the one or more second data centers as destination data centers for creation of remote copies to one or more volumes based on the complementary score; and
executing, by the data center management server, creation of the remote copies to the one or more second data centers; and
controlling, by the data center management server, migration of the workloads between the first data center and the one or more second data centers by swapping volume attributes between primary and secondary volumes in response to renewable energy supply at the first data center falling below a threshold to control use of renewable energy in executing workloads and reduce carbon emissions from the plurality of data centers.

8. The workload control method of claim 7, further comprising controlling the migration by changing an attribute of a volume in the one or more second data centers having excess renewable energy to a primary volume. and changing an attribute of a volume in the first data center to a secondary volume, wherein the remote copies are made from the primary volume to the secondary volume.

9. The workload control method of claim 7, wherein the swapping the volume attributes comprises by:
determining whether there is excess renewable energy at the one or more second data centers; and
in response to determining there is excess renewable energy, changing an attribute of a volume in the one or more second data centers to a primary volume and changing an attribute of a volume in the first data center to a secondary volume, wherein the remote copies are made from the primary volume to the secondary volume.

10. The method of claim 7, wherein the determining the one or more second data centers as the destination data centers is based on one or more of: a number of remote copies to be created, capacity of the one or more second data centers, or from selecting from ones of the one or more second data centers having a remote copy pair count that has not reached a threshold.

11. The method of claim 7, wherein the calculating the complementary score is based on a standard deviation of a sum of: time series data of the past renewable energy supply at the each of the plurality of data centers and the time-series data of the past renewable energy supply at the first data center.

12. The method of claim 7, further comprising:
providing an interface for generating a remote copy creation request, wherein the creation of the remote copies is executed by creating secondary volumes at the one or more second data centers and initiating copying of data from primary volumes to the secondary volumes in response to the remote copy creation request from the interface:
wherein for a renewable energy ratio of the first data center falling below a threshold, relocating execution of the applications from servers at the first data center to servers at the one or more second data centers.

13. A non-transitory computer readable medium, storing instructions that, when executed by a processor of a data center management server, cause the processor to perform a workload control process for controlling migration of workloads between a first data center and one or more second data centers from a plurality of data centers based on renewable energy supply, the process comprising:
calculating a complementary score of each of the plurality of data centers based on information of time-series data of past renewable energy supply at the each of the plurality of data centers,
determining the one or more second data centers as destination data centers for creation of remote copies to one or more volumes based on the complementary score; and
executing creation of the remote copies to the one or more second data centers; and
controlling migration of the workloads between the first data center and the one or more second data centers by swapping volume attributes between primary and secondary volumes in response to renewable energy supply at the first data center falling below a threshold to control use of renewable energy in executing workloads and reduce carbon emissions from the plurality of data centers.

14. The non-transitory computer readable medium of claim 13, the process further comprising controlling the migration by changing an attribute of a volume in the one or more second data centers having excess renewable energy to a primary volume, and changing an attribute of a volume in the first data center to a secondary volume, wherein the remote copies are made from the primary volume to the secondary volume.

15. The non-transitory computer readable medium of claim 13, wherein the swapping the volume attributes comprises by:
determining whether there is excess renewable energy at the one or more second data centers; and
in response to determining there is excess renewable energy, changing an attribute of a volume in the one or more second data centers to a primary volume and changing an attribute of a volume in the first data center to a secondary volume, wherein the remote copies are made from the primary volume to the secondary volume.

16. The non-transitory computer readable medium of claim 13, wherein the determining the one or more second data centers as the destination data centers is based on one or more of: a number of remote copies to be created, capacity of the one or more second data centers, or from selecting from ones of the one or more second data centers having a remote copy pair count that has not reached a threshold.

17. The non-transitory computer readable medium of claim 13, wherein the calculating the complementary score is based on a standard deviation of a sum of: time series data of the past renewable energy supply at the each of the plurality of data centers and the time-series data of the past renewable energy supply at the first data center.

18. The non-transitory computer readable medium of claim 13, the process further comprising:
providing an interface for generating a remote copy creation request, wherein the execution of the creation of the remote copies is conducted to execute the creation of the remote copies to the one or more second data centers in response to the remote copy creation request from the interface;
wherein for a renewable energy ratio of the first data center falling below a threshold, relocating execution of the applications from servers at the first data center to servers at the one or more second data centers.
